(19) United States
(12) Patent Application Publication
(10) Pub. No.: US 2011/0211701 A1
(43) Pub. Date: Sep. 1, 2011

(54) METHOD FOR EXCHANGING KEYS BY INDEXATION IN A MULTIPATH NETWORK

(76) Inventors: Eric Grall, Quimper (FR); Nicolas Sintes, Tours (FR)

(21) Appl. No.: 12/809,527

(22) PCT Filed: Dec. 18, 2008
(86) PCT No.: PCT/EP08/67923

§ 371 Date: May 18, 2011

(30) Foreign Application Priority Data
Dec. 18, 2007 (FR) 0708837

(51) Int. Cl. H04L 9/08

(52) U.S. Cl. 380/283

(57) ABSTRACT

A method for generating encryption keys and for exchanging the parameters making it possible to generate the keys in a network comprising n entities X wishing to exchange data, the method includes the steps: the n entities elect a common array generator (G_{M}(λ)), at least one of the entities X communicates these values (λᵢ) via several different routing paths Ci, plus a reference random number N^{X}, N^{Y}, each entity X, Y generates an array Tₛ, each entity X, Y composes a secret key based on the generated array (Tₛ) and based on several values indexed by several pairs ((i,j); (k,l); . . . ; (o,p)) of said array in order to create its secret value, the random number of a first entity X is returned to a second entity Y, one of the n entities X, Y at least compares the consistency of the two values N^{X} after decryption with its own key K^{X}s.

### FIELD OF THE INVENTION

The invention relates to a method and system making it possible to generate encryption keys in a communication network and to exchange keys by indexation in a multipath network.

### BACKGROUND

Various methods are known for solving the problem of security during exchanges of data between several users, or between a user and a system, or between two systems.

The networks concerned are fixed networks or Ad hoc networks. As a reminder, Ad hoc networks are formed via the automatic configuration of the routing tables of each of the communicating nodes forming an integral part of the network.

In a fixed network, the problem of security is usually solved via key management infrastructure systems (known by the abbreviation IGC) allowing the sharing of a symmetric key or of a certificate (asymmetric key) between the entities of the communicating network. This generalization is not always desirable because of the complexity of implementing an IGC infrastructure. In this context, the protection of a channel between two users must be able to withstand a large number of hacking attacks without the external aid of an IGC.

In an ad hoc network, the problem is all the greater because the notion of infrastructure of keys is practically nonexistent because of the very mobility and volatility of the ad hoc topology. Specifically, an ad hoc network is a network in which the routing of information is carried out by the nodes making up the network. There are therefore no fixed routing infrastructures allowing knowledge of the overall network topology. Each of the network nodes behaves like a router with these adjacent nodes. In this context, the technical problems to be solved are of several orders, for example:
each of the nodes must be able, at a given moment, to know a portion of the network topology in order to be able to communicate with a destination node. This problem is solved partly by protocols called proactive and reactive protocols, these terms being known to those skilled in the art.
trust in the network is one of the major problems in the context of ad hoc networks. Specifically, the routing information and the user information travel via communication nodes that are private, therefore with a zero trust level. Since the Ad hoc network is by nature mobile, no trust system based on the centralization of information such as a public key infrastructure can be produced in this context. Specifically, the validation must be carried out by the trust system.

In the case of a fixed network, to solve the problem of security during data exchanges, it is known practice to use the internet key exchange protocol (abbreviated to IKE), which makes it possible to share a common secret in order to protect the exchange between two entities. This protocol is described by RFC 2409 of the IETF which is available at the Internet address www.ietf.org/rfc/rfc2409.txt. There are several kinds of drawbacks to the IKE standard:
on the one hand, the length of the exchanges between the two partners which causes an overload in the bandwidth of the network,
on the other hand, it allows verification of the secret based only on a pre-shared key or certificate via an organizational means that is not in communication,
moreover, this protocol is not suitable for management of an ad hoc network and is therefore vulnerable to hacking of the MIM (Men In The Middle) type.

A banking system can use a principle of disposable masks constructed by values in an array, and used for the creation of a password via the linking of their coordinates (known as a “One Time Pad”). The method is used statically, and does not always make it possible to achieve the security levels required by certain applications.

Despite all the benefits that they provide, the systems and methods according to the prior art have the following drawbacks:
in the case of the value array used in the banking field, this array is static and cannot therefore be regenerated on each of the sessions. Moreover, the size of the value array is relatively small and does not allow the formation of high-security secret elements.
this prior art makes it possible to share a secret between two entities of a fixed network via a simple routing link. However, this secret is validated by the encryption and verification of said secret by a pre-shared key (PSK) or by a certificate supplied by a key management infrastructure (or Public Key Infrastructure, PKI).

### SUMMARY OF THE INVENTION

Embodiments of the invention are based on a principle of defining a common secret key or session key (symmetric context), considering the capability of the network to offer several routing paths between at least two communicating entities.

An embodiment of the invention relates to a method making it possible to generate encryption keys and to exchange parameters making it possible to generate said keys in a network comprising n entities X wishing to exchange data, the method comprises at least the following steps:
the n entities elect a common array generator (G_{M}(λ)), said array being defined as a function dependent on a set of parameters (λᵢ) in which the value λ₀ is designated as the initial value x₀ and Gₘ(λ)=ƒ(λₙ,x₀)=ƒ(λₙ)=ƒ(λ);
at least one of the entities X communicates these values (λᵢ) via several different routing paths Ci, plus a reference random number N^{X}, N^{Y} to another entity Y with which it wishes to exchange information,
each entity X, Y generates an array Tₛ of dimension m×m based on the generator with values λᵢ, by cutting the results of the generator into blocks of k bits where xⱼ=Γₖ(G_{M}(λ)) and Tₛ=[xⱼ]₀^{m} where Γₖ(G_{M}(λ)) defines the formatting of the array Tₛ in blocks of k bits,
each entity X, Y composes a secret key based on the generated array (Tₛ) and based on several values indexed by several pairs (i,j); (k,l); . . . ; (o,p)) of said array in order to create its secret value K^{X}_{S} via an H function such that: K^{X}_{S}=H((i,j); (k,l); . . . ; (o,p)), K^{Y}S=H((i,j); (k,l); . . . ; (o,p)),
the indexation pairs used to generate the secret key are chosen by the entity X, Y or transmitted by an entity via the N different routing paths in order to allow an entity Y, X to construct the same secret element (K_{S}),
the random number of a first entity X is returned to a second entity Y, the random number being encrypted by the key of the second entity, Y communicates to the entity X the random number or “nonce” referenced N^{X} encrypted by its key K^{Y}s, and/or X communicates to the entity Y its random number N^{Y} encrypted by the key K^{X}s generated by X,
one of the n entities X, Y at least compares the consistency of the two values N^{X} after decryption with its own key K^{X}s.

The invention may be used in ad hoc networks, networks in which the node configuration can change over time. Aspects of the invention can be applied to all types of network that can accommodate multipath routing. It is used, for example, in mesh networks, IP networks of the MPLS (Multi-Protocol Label Switching) type. The dispersion of the elements depends only on the principle of distribution of the elements over several routes.

### BRIEF DESCRIPTION OF THE DRAWINGS

Other features and advantages will appear on reading the following detailed and nonlimiting description given as an example and made with respect to the appended drawings which represent:

FIG. 1, an array of values generated by a generator at a first entity exchanging information with a second entity,

FIG. 2, the indexation of the values for the composition of the key or secret,

FIG. 3, an example of a multipath network, with a first entity A communicating with a second entity B,

FIG. 4, the transmission of the parameters of the generator G_{M} from the entity A to the entity B using several paths,

FIG. 5, the communication of the indexation pairs from the entity A to the entity B via the different paths,

FIG. 6, a variant of FIG. 5 in which the indexation pairs are transmitted, for one portion by the entity A, and for the other portion by the entity B,

FIG. 7, the exchange protocol used for n entities, and

FIG. 8, the format of the IP protocol.

### DETAILED DESCRIPTION OF THE PREFERRED EMBODIMENTS

In summary, the protocol for generation and exchanges of keys according to an embodiment of the invention involves exchanging parameters making it possible to generate dynamically an array of values used to create a secret element between two entities, the generation of arrays being carried out at each of the entities requiring to exchange information between them in a secure manner.

The method relates therefore to a protocol for exchanging secret keys using a mechanism for distributing generators of arrays designated (G_{M}(λ)) between two or more entities so that each of the entities can form an array called (Tₛ). Based on this array (Tₛ), the entities will then compose a common secret via the exchange of an index pair (corresponding to a column/row) of the array (Tₛ), for example the set of pairs {(i,j); (k,l); . . . ; (o,p)} in order to create in a unitary manner a symmetric secret key between the two entities which will be used for the encryption of the communication channel.

The generator will be defined by a mathematic operation with coefficients (λᵢ), by an indexation mechanism making possible a choice of several values in an array dynamically created by the generator (G_{M}(λ)), and by an operation of generating a secret based on preselected values of the array.

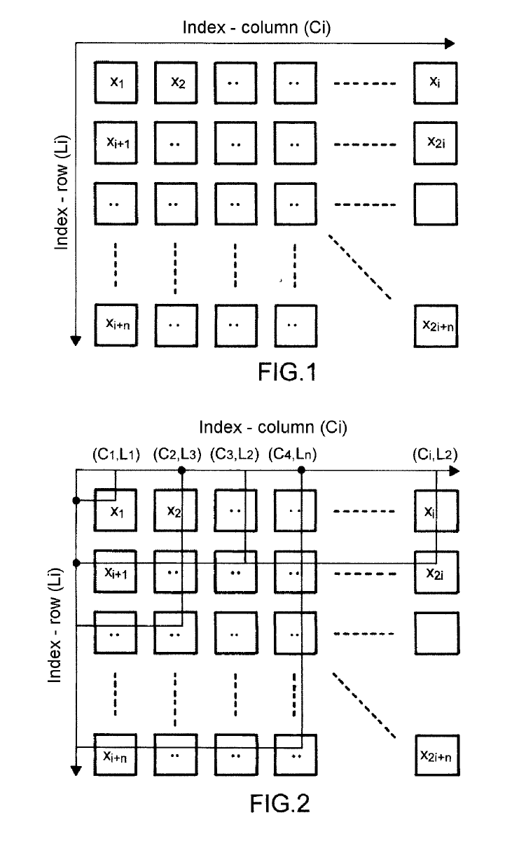

FIGS. 1, 2, 3, 4 and 5 illustrate an application of the method according to an embodiment of the invention.

An entity that will apply the method comprises data transmission means, reception means and a processor for executing the various steps described below for various embodiments.

The method used is based on the use of several phases described below. In order to simplify understanding of the invention, the first exemplary embodiment of the method relates to two entities wishing to exchange information in a secure manner.

Phase 1

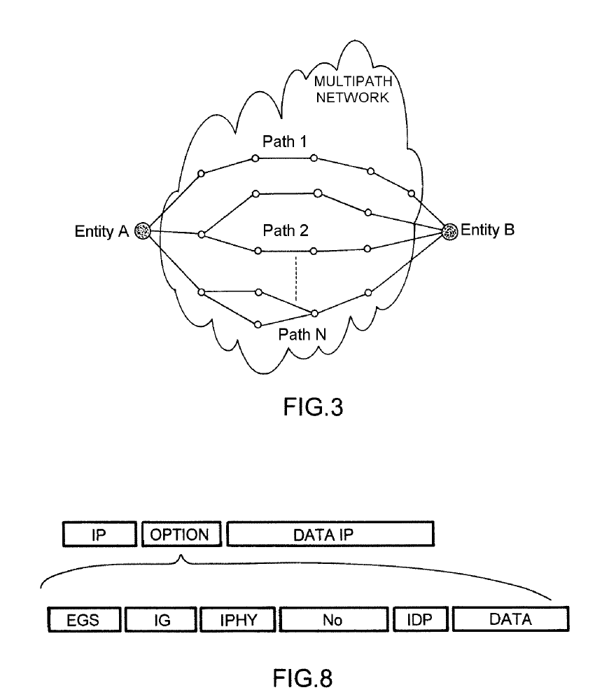

In the example of FIG. 3, two entities A and B agree on the type of mathematical generators. In this context, many possibilities can be used for the generator (G_{M}(λ)). The nominal condition for choosing it is that the generator should be able to be defined as a function dependant on a set of parameters (λᵢ). These generators will appear in the form of a function of several parameters (λᵢ) in which the value λ₀ will be designated as the initial value x₀ and G_{M}(λ)=ƒ(λₙ, xₒ)=ƒ(λₙ)=ƒ(λ).

It is possible to use as a generator the Mojette transform known to those skilled in the art. This discrete Radon mathematical transform makes it possible to project an example of data from a space of dimension N onto a space of dimension N−1. This transform has the necessary “parceling” and “security” properties in the context of the method according to the invention and of the concept of associated ghosts. In the context of the Mojette transform, a ghost is defined as a structural element such that its projection with respect to the Mojette transform in the direction of construction is zero. The principle of ghosts is used in the present invention in order to construct sets of projections that are consistent with one another in order to generate arrays that are perfectly reconstructible in this given set. This therefore makes it possible to have a generator system weighted in the sense (λᵢ) by several Mojette ghosts in order to construct a base of predictable arrays by application of the inverse Mojette. “Ref. O. Philippé, Représentation Multiple de I'Information Mojette, Thèse de doctorat, Sciences pour l'ingenieur, 1995” [Ref. O. Philippé, Multiple representation of Mojette information, doctorate thesis, Science for the engineer, 1995].

Another generator is based on a chaotic equation of the Chua or Lorentz type (Ref. Pierre Bergé, Yves Pomeau & Christian Vidal; L'ordre dans le chaos—Vers une approche deterministe de la turbulence [Order in chaos—toward a deterministic approach to turbulence], Hermann—1988). The Chua oscillator is the prototype of the electronic oscillators having a transition from periodicity to chaos. It is based on differential equations using nonlinear elements of which the transition to a strange or non-asymptotically unstable attractor relies on the choice of several parameters.

Another possibility is to use a generator based on a polygonal equation of the error-correction type.

Phase 2

In the first variant, one of the two entities will be the master in the exchange between the two users. The entity A will choose the parameters of the generator (λᵢ) allowing a generation by the generator (G_{M}(λ)) of values with a high level of security.

In the case of the chaotic generator, these values will correspond to a generation of a strange, therefore chaotic or asymptotically unstable attractor. In the case of the Mojette transform, these parameters will correspond to a sequence of “ghost” projections making it possible to generate sequences of coherent projections.

Phase 3

The entity A will communicate these values (λᵢ) via several different routing paths Ci (FIG. 5), plus a reference Nonce (random number) N^{A}. The values (λᵢ) will either be sent directly, or they will be projected to an equivalent set (δᵢ) via a function Ψ such that δᵢ=Ψ(λⱼ). This function may have, amongst other things, redundancy properties, or properties of mathematical complexity in the cryptographic sense such that a hacker cannot easily recalculate the values (λᵢ) based on the set (δᵢ): δᵢ=Ψ(λⱼ).
Path 1 (from A to B): the values N^{A}, λ₁, or N^{A}, δ₁
path 2 (from A to B): the values N^{A}, λ₂, or N^{A}, δ₂
. . .
path n (from A to B): the values N^{A}, λₙ, or N^{A}, δₙ

In the description, the equations and the protocol will be described with the parameters λᵢ, considering that the use of the parameters δᵢ is only a generalization of the principle of the invention. Specifically, the parameters δᵢ are nothing but the set of possible projections of a function Ψ on the input parameters λᵢ of the generator G_{M}(λ), with notably the unitary function λⱼ=δᵢ=Ψ(λⱼ) which associates itself with each parameter λᵢ. The use of the parameters δᵢ via the projection function Ψ makes it possible, via an additional operation in the protocol δᵢ=Ψ(λⱼ), to add to the protocol one or more (mathematical) properties specific to the projection function Ψ.

Phase 4

The two entities will then generate an array (Tₛ) of dimension m×m (FIG. 1) based on the generator with values (λᵢ), by cutting the results of the generator into blocks of k bits as follows:

where xⱼ=Γₖ(G_{M}(λ)) and Tₛ=[xⱼ]₀^{m}, where Γₖ(G_{M}(λ)) defines the formatting of the array Tₛ in blocks of k bits. Since this function is known in this field, it will not be described.

Array (Tₛ)

| | | | |
|---|---|---|---|
| x₁ | x₂ | . . . | . . . |
| . . . | | . . . | . . . |
| . . . | . . . | x_{o×p} | . . . |
| . . . | . . . | . . . | . . . |
| . . . | . . . | . . . | . . . |
| x_{1×m} | | | x_{m×m} |

Phase 5

The entity A will compose a secret key based on the generated array (Tₛ) and based on several values indexed by several pairs ((i,j); (k,l); . . . ; (o,p)) of the array. Considering the array above, the entity A will take index pairs ((i,j); (k,l); . . . ; (o,p)), corresponding to the row and the column of the array (FIG. 2) in order to create its secret value (K^{A}s) via an H function such that K^{A}s=H((i,j); (k,l); . . . ; (o,p))

Generally, the H function makes it possible based on several input elements to generate a single output element (or with a low value of statistical appearance), which is the case with the hash functions: u=H(x; y; . . . ; z). Usually, this H function can be a hash function of the SHA 256 type, or more simply a concatenation function.

In the case of a Mojette generator G_{M}(λ) this H function will be an inverse Mojette transform marked M⁻¹.
Array II below represents the chosen pairs

| | | | |
|---|---|---|---|
| (i, j) | x₂ | . . . | . . . |
| . . . | . . . | . . . | . . . |
| . . . | . . . | . . . | . . . |
| . . . | (k, l) | . . . | . . . |
| . . . | . . . | . . . | (o, p) |
| x_{1×m} | . . . | . . . | x_{m×m} |

Phase 6

The entity A will communicate the chosen indexation pairs via the N different routing paths (FIG. 5) in order to allow the entity B to construct the same secret element (Kₛ):
path 1 (from A to B): the pair (i,j), (L1, C1)
path 2 (from A to B): the pair (k,l), (L2, C3)
. . .
path N+1 (from A to B): the pair (o,p), (Ln, Cn).

Phase 7

The entity B will then create its secret key K^{B}s=H((i,j); (k,l); . . . ; (o,p)) based on the retrieved indexation parameters and will then communicate to the entity A the random number or “nonce” reference N^{A} encrypted by its key K^{B}s. The entity A will compare the consistency of the two values N^{A} after decryption with its own key Kₛ^{A}.

If there is consistency between the two values, the generated secret key can be used to encrypt and secure data exchanges or the communication channel.

The principle can be easily adapted so that the two entities share the choice of the parameters, that is to say namely the parameters λ of the generator G_{M}(λ). In this case, there is a mutual authentication between the players via the random numbers or “Nonces” shared between the two entities:
path 1 (from A to B): the values N^{A}, λ₁, or N^{A}, δ₁
path 2 (from A to B): the values N^{A}, λ₂, or N^{A}, δ₂
. . .
path N−1 (from B to A): the values N^{B}, λₙ, or N^{B}, δₙ
path N (from B to A): the values N^{B}, λ₂, or N^{B}, δₙ

Specifically, at the end of applying the method, as the entity B returns the Nonce N^{A} of the entity A, A in return will communicate to the entity B the nonce reference N^{B} encrypted by its key K^{A}s. The entity B will compare the consistency of the two values N^{B} after decryption with its own key K^{B}s

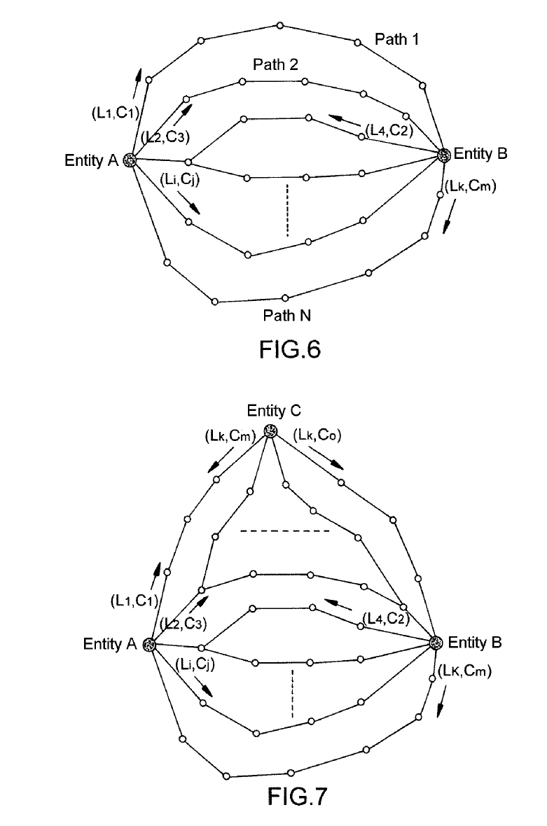

FIG. 6 shows a variant embodiment in which the communication of the indexation pairs previously defined is carried out in one portion by the entity A and for another portion by the entity B. The entity A communicates only a portion of the indexation pairs C_{A}=((i,j); (k,l); . . . ; (o,p)), and the entity B communicates to it another portion C_{B}=((q,r); (s,t); . . . ; (u,v)). This variant allows each of the entities to be involved in the key-creation process. Specifically, the calculation of the secret key between the two portions will then be carried out by the application of the H function to the totality of the indexation pairs chosen by the two entities: K_{S}=((i,j); (k,l); . . . ; (o,p); (q,r); (s,t); . . . ; (u,v)).
Path 1 (from A to B): value (i,j),
path 2 (from A to B): value (k,l),
. . .
path m (from A to B): value (o,p)
path m+1 (from B to A): value (q,r),
. . .
path n (from B to A): value (u,v).

FIG. 7 represents the extension of the method according to the invention for an exchange between N units. FIG. 7 illustrates the case in which N=3. The communications will no longer be made in a one-to-one basis (or unicast), but on messages (multicast) targeting the other entities that have to create the common secret of the trust group formed by them. In the example shown in FIG. 7, the entity A will communicate the values (λᵢ) to the other two entities of the trust group, B and C. In this context, each of the entities (A, B and C) will create its pairs of values and will communicate them to each of the peer entities (A to B and C; B to A and C; C to A and B).

The method described above does not provide particular protection mechanisms except for the multipath distribution, making it possible to protect the communication of the parameters λᵢ of the generator between at least two entities.

A variant of the method consists in using a principle of three-pass exchange described by SHAMIR in the book “Cryptographie Appliqué [Applied Cryptography], B. Schneier, Thomson Publishing, Chap. 16, Protocole à trois passes de SHAMIR [SHAMIR three-pass protocol] (Ref. “John Clark and Jeremy Jacob; A survey of Authentication protocol literature, November 1997”) with a commutative cryptographic algorithm, and an additional message phase will be necessary in the two entities relative to the original protocol.

By defining the projection function Ψ as a modulo p factoring close to RSA, in which:

let p be a large prime number such that p−1 has a large prime number. All the entities have an encryption and decryption key e and d that must be prime with p−1 and ed≡1. The projection function Ψ is then defined as: Ψ(x)=x^{a} mod p, where α=c for the transmission, α=d in reception.

In this context, the exchange protocol can be defined by following a scheme described above with the following phases:

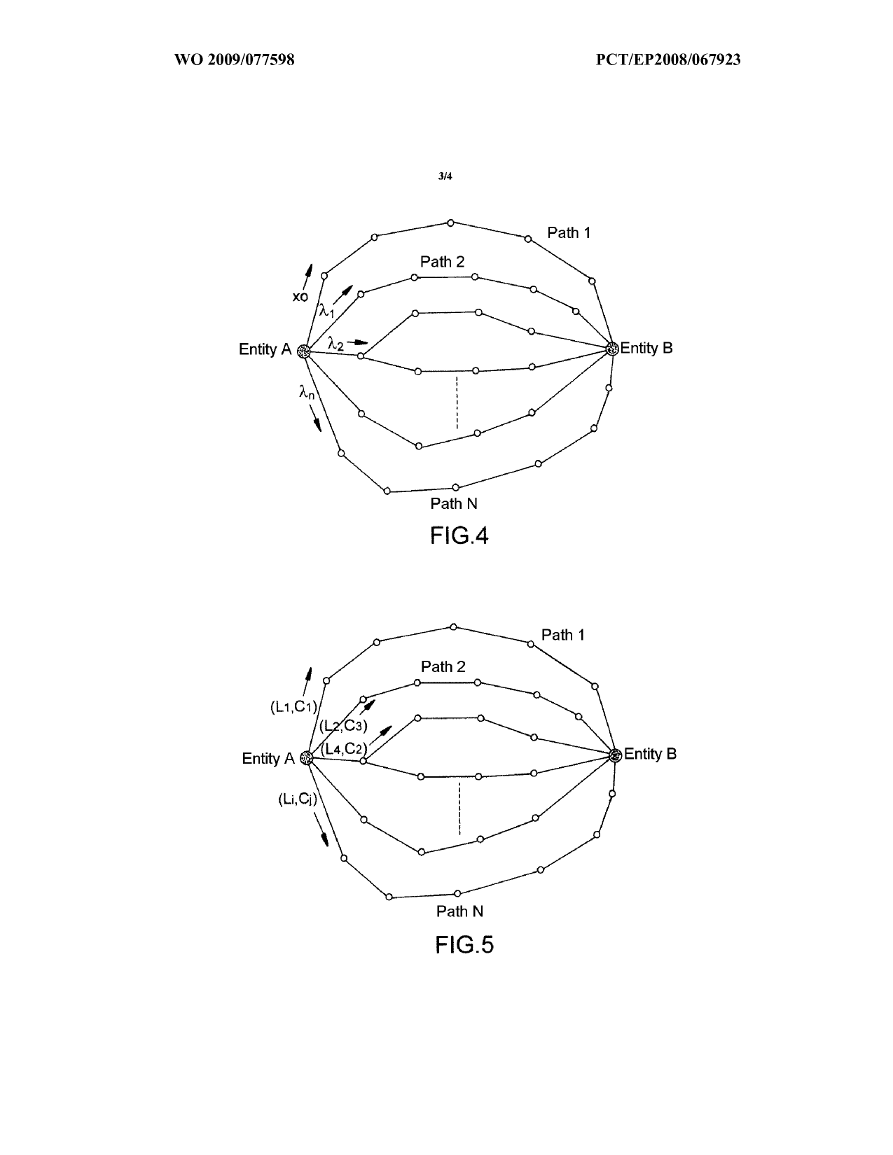

the entity A will communicate the values δᵢ via different routing paths (FIG. 4), plus a reference random number “Nonce”. The values δᵢ are the projections via the function Ψ: δᵢ=Ψ(λⱼ)=(λᵢ)^{a} mod p;
path 1 (from A to B): the values N^{A}, δ₁, where α=c,
path 2 (from A to B): the values N^{A}, δ₂, where α=c,
. . .
path n (from A to B): the values N^{A}, δₙ, where α=c.

The entity B will project the values δᵢ with its own function Ψ defined in the same manner as above. This will give the projection values of B defined by: ωᵢ=Ψ(δⱼ)=(δᵢ)^{β} mod p, where β=e for transmission, β=0 in reception. Then B will return these values ωᵢ to the entity A on multiple paths.
Path 1 (from B to A): the values N^{B}ωᵢ, where β=e,
path 2 (from B to A): the values N^{B},ω₂, where β=e,
. . .
path n (from B to A): the values N^{B},ωₙ, where β=e.

The entity A will decrypt the values ωᵢ with its key α=d, and, knowing the values δᵢ, will be able to retrieve the encryption key e of the entity B (specifically, the functions Ψ are commutative), and will then use it in order to encrypt the values of the generator λᵢ in a secure manner:
path 1 (from A to B): the values δᵢ where α=e,
path 2 (from A to B): the values δ₂, where α=e,
. . .
path n (from A to B): the values δₙ, where α=e.

The entity B will decrypt the values δᵢ with its decryption key β=o, and will retrieve the values λᵢ of the generator in order to create the array as described in the original protocol.

It is also possible according to another variant embodiment to use mechanisms of particular redundancy in the case of interception of one of the parameters λᵢ of the generator between the two entities. In this context, a variant is to define as a projection function Ψ a redundant function incorporating redundancy mechanisms making it possible to define parameters δᵢ composed based on the parameters λᵢ. This will then mean that the two entities have to retrieve only a portion of the parameters δᵢ in order to recompose the parameters λᵢ, and therefore to reconstitute the generator G_{M}(λ).

Accordingly, it is possible to cite the example of the Mojette transform or of the Reed Solomon code, having these redundancy properties in order to define the function Ψ.

The parameters δᵢ are then defined as: δᵢ=Ψ(λⱼ), where 0<j<n and 0<i<m, such that a portion k of the parameters δᵢ can recompose all the parameters λᵢ, where 0<k<n.

FIG. 8 shows the format of the protocol in the case of an implementation of the method according to the invention in an IP sub network in the form of an Ipv4 or Ipv6 option.

In the context of an IP or equivalent network, we can use the distributed protocol for exchange of keys by incorporating it in a representative manner (FIG. 4) in the data of the protocol format.

Frame identifier: ESG (ESG: Exchange of Secret by Generator)

Identifier of the generator: IG

Identifier of the projection function (option): IPHY

The value of the Nonce: No

Identifier of the fields of the generator: IDP

The data: Data, Values of the segment parameter (parameters λᵢ or δᵢ).

The method and the system according to the invention provide a protocol solution that solves, on the one hand, the problem of the obligation to possess a key that is pre-shared between the communicating entities and, on the other hand, the risk of MIM (Men In The Middle) hacking associated with the Diffie-Hellman sharing, by proposing a mechanism for broadcasting a secret generator (G_{M}(λ)) over several routing paths (FIG. 3), while broadcasting the generator via these director parameters over the different paths.

This protocol does not require a key or certificate that is pre-shared between the two entities. Each entity must be able to recalculate the common secret based on a redundant set of portions of the original secret and verify the consistency of this secret between the two entities.

This protocol can spread the load of the requests for the negotiation of keys over several paths. The protocol itself takes only two messages per partner (Phase 1 and Phase 2).

1. A method for generating encryption keys and for exchanging the parameters making it possible to generate said keys in a network comprising n entities, A, B, X, Y wishing to exchange data, comprising at least the following steps:
the n entities of said network elect a common generator of arrays (G_{M}(λ)), said array Ts being defined as a function dependent on a set of parameters (λᵢ) in which the value λ₀ is designated as being the initial value x₀ and at least one of the entities X communicates each of said values (λᵢ) via several different routing paths Ci, a value following a given path plus a reference random number N^{X}, N^{Y} to another entity Y with which it wishes to exchange information in a secure manner, said array generator is defined by a mathematical operation with coefficients (λᵢ), by an indexation mechanism allowing a choice of several values in an array dynamically created by the generator (G_{M}(λ)), and by an operation for generating a secret based on the previously-chosen values of the array
each of the entities X, Y of said network generates an array Tₛ of dimension m×m based on the generator with values λᵢ, by cutting the results of the generator into blocks of k bits where xⱼ=Γₖ(G_{M}(λ)) and Tₛ=[xⱼ]₀^{m} where Γₖ(G_{M}(λ)) defines the function of formatting in blocks of k bits of the array Tₛ
each entity X or Y composes a secret key based on the array (Tₛ) generated and based on several values indexed by several pairs ((i,j); (k,l); . . . ; (o,p)) of said array in order to create its secret value K^{X}S via an H function such that K^{X}_{S}=H((i,j); (k,l); . . . ; (o,p)), K^{Y}S=H((i,j); (k,l); . . . ; (o,p)), one indexation pair corresponding to one column/line pair of said array Ts,
the indexation pairs chosen to generate the secret key are chosen by the entity X, Y or transmitted by an entity via the N different routing paths, in order to allow an entity Y, X to construct the same secret element (K_{S})
the random number of a first entity X is returned to a second entity Y, the random number being encrypted by the key of the second entity, Y communicates to the entity X the random number or “nonce” referenced N^{X} encrypted by its key K^{Y}s, and/or X communicates to the entity Y its random number N^{Y} encrypted by the key K^{X}s generated by X,
one of the n entities X or Y of said network at least compares the consistency of the two values N^{X} after decryption with its own key K^{X}s.

2. The method as claimed in claim 1, wherein the values of the parameters (λᵢ) are chosen by a single entity A and in that the indexation pairs are transmitted by this same entity A to the other entities of the network and in that the entity A generates its secret value (K^{A}s) via an H function such that K^{A}s=H((i,j); (k,l); . . . ; (o,p))
the entity A communicates the chosen indexation pairs via the N different routing paths in order to allow the entity B to construct the same secret element (Kₛ), wherein the routing paths include:
path 1 (from A to B): the pair (i,j), (L1, C1)
path 2 (from A to B): the pair (k,l), (L2, C3)
. . .
path N+1 (from A to B): the pair (o,p), (Li, Cj)
the entity B creates its secret key K^{B}s=H((i,j); (k,l); . . . ; (o,p)) based on the retrieved indexation parameters, then communicates to the entity A the random number or “nonce” reference N^{A} encrypted by its key K^{B}s,
the entity A compares the consistency of the two values N^{A} after decryption with its own key Kₛ^{A}.

3. The method as claimed in claim 1, wherein, for two entities A, B exchanging information, the method comprises the following steps:
the choice of the parameters λ of the array generator G_{M}(λ) be shared between said entities A, B;
exchanging said parameters by using n distinct paths, which include:
path 1 (from A to B): the values N^{A}, λ₁,
path 2 (from A to B): the values N^{A}, λ₂,
. . .
path n−1 (from B to A): the values N^{B}, λₙ,
path n (from B to A): the values N^{B}, λₙ,
the entity B returns the Nonce N^{A} of the entity A, A in return communicates to the entity B the nonce reference N^{B} encrypted by its key K^{A}s,
the entity B compares the consistency of the two values N^{B} after decryption with its own key K^{B}s.

4. The method as claimed in claim 1, wherein the exchange between two entities comprises the following steps:
the entity A communicates a portion of the indexation pairs C_{A}=((i,j); (k,l); . . . ; (o,p)), and the entity B communicates to it another portion C_{B}=((q,r); (s,t); . . . ; (u,v)),
the calculation of the secret key between the two portions is carried out by the application of the H function to the totality of the indexation pairs chosen by the two entities:
Kₛ=H((i,j); (k,l); . . . ; (o,p); (q,r); (s,t); . . . ; (u,v)), wherein the routing paths include:
Path 1 (from A to B): value (i,j),
path 2 (from A to B): value (k,l),
. . .
path m (from A to B): value (o,p)
path m+1 (from B to A): value (q,r),
. . .
path n (from B to A): value (u,v).

5. The method as claimed in claim 1, wherein the network comprises N entities and the exchanges are carried out in “multicast” targeting the entities that have to create the common secret in a trust group.

6. The method as claimed in claim 1, wherein the values of the parameters λ are projected to an equivalent set by using a secure function having cryptographic properties such that a hacker cannot recalculate the values of the initial parameters.

7. The method as claimed in claim 1, wherein, for the array generator, the generator is selected from the group consisting of: the Mojette transform, a chaotic equation of the Chua or Lorentz type, a generator based on a polygonal equation of the error-correction type.

8. The method as claimed in claim 1, wherein the H function is a hash function or a concatenation function.

9. The method as claimed in claim 1, wherein it uses a redundant function as the projection function.

10. The method as claimed in claim 1, wherein it is applied in an IP subnetwork, and in that the protocol format is determined as follows:
Frame identifier: ESG (ESG: Exchange of Secret by Generator)
Identifier of the generator: IG
Identifier of the projection function (option): IPHY
The value of the Nonce: No
Identifier of the fields of the generator: IDP
The data: Data, Values of the segment parameter (parameters λᵢ or δᵢ).
